(19) United States
(12) Patent Application Publication
(10) Pub. No.: US 2026/0042353 A1
(43) Pub. Date: Feb. 12, 2026

(54) METHOD FOR CONTROLLING AN OPERATION OF A SEPARATELY EXCITED ELECTRIC MACHINE

(71) Applicant: ZF Friedrichshafen AG, Friedrichshafen (DE)

(72) Inventors: Florian ULLRICH, Gerolzhofen (DE); Sebastian WENDEL, Arnstein (DE); Andreas KRÄMER, Bad Neustadt (DE); Luis AYALA, Markdorf (DE); Robin MICHELBERGER, Schweinfurt (DE)

(73) Assignee: ZF Friedrichshafen AG, Friedrichshafen (DE)

(21) Appl. No.: 19/281,070

(22) Filed: Jul. 25, 2025

(30) Foreign Application Priority Data
Aug. 7, 2024 (DE) 102024207493.4

(51) Int. Cl. B60L 3/00; B60L 3/12; H02P 29/032

(52) U.S. Cl. CPC B60L 3/0061; B60L 3/12; H02P 29/032; B60L 2240/425; B60L 2240/427; B60L 2240/429

(57) ABSTRACT

A method for controlling an operation of a separately excited electric machine, particularly of a motor vehicle, in a fault condition. The following steps are performed in the method: (1) detecting a present current vector, particularly a stator current vector, and/or a current angle, particularly a stator current angle, of the separately excited electric machine; (2) determining a variation voltage vector depending on the detected present current vector and/or current angle; (3) changing the present operating point of the separately excited electric machine to a changed operating point by setting the variation voltage vector, wherein the power generated by the change in the operating point is equal to the power loss, particularly the thermal power loss, of the separately excited electric machine, or is less than the power loss, particularly the thermal power loss, of the separately excited electric machine; and (4) executing an active short-circuit state proceeding from the changed operating point.

### BACKGROUND OF THE INVENTION

### 1. Field of the Invention

The invention is directed to a method for controlling an operation of a separately excited electric machine, particularly of a motor vehicle, in a fault condition.

### 2. Description of the Related Art

Methods for controlling the operation of separately excited electric machines, in particular for motor vehicles, in which a fault condition occurs in operation are known in principle from the prior art. For example, it is known that when a fault condition occurs the separately excited electric machine or the drive arrangement comprising it is to be brought into a safe state. To this end, for example, the present operation is adjusted and the separately excited electric machine is operated such that the DC link is discharged for transitioning to the safe state. In particular, a so-called “active short-circuit state” (ASC) in which, for example, the high-side switches or the low-side switches of the inverter associated with the separately excited electric machine are switched simultaneously is carried out for transitioning to the safe state. In other words, the phases of the separately excited electric machine are short circuited in order to transition to the safe state.

Depending on the operating state from which the transition to the safe state is to take place, i.e., the operating state in which the fault condition occurs, it is possible that high transient currents are generated when the active short-circuit state is carried out, particularly when the electrical energy storage is uncoupled or “dumped” under the fault condition. These high transient currents can lead to damage to or destruction of electronic components of the separately excited electric machine.

### SUMMARY OF THE INVENTION

It is an object of the invention to provide a method for controlling the operation of a separately excited electric machine in a fault condition which is improved over the prior art and in which it is possible to transition to a safe state without risking damage to electronic components.

The invention is particularly directed to a separately excited electric machine of a motor vehicle, in a fault condition. The separately excited electric machine may be a component part of an electric drive arrangement of the motor vehicle, i.e., the motor vehicle can be driven by the separately excited electric machine as drive device. The usual components, for example, an inverter, an electrical energy storage and the like, are associated with the separately excited electric machine in the drive arrangement. The control of the operation of the separately excited electric machine can be carried out in particular by means of the inverter in that the inverter outputs corresponding electric voltages to adjust currents in the separately excited electric machine. As was described above, the electric machine is to be transitioned to a safe state, particularly by executing an active short-circuit state, when a fault condition occurs.

The invention is based on the understanding that the method comprises the following steps:
detecting a present current vector, particularly a stator current vector and/or a current angle, particularly a stator current angle, of the separately excited electric machine;
determining a variation voltage vector depending on the detected present current vector and/or current angle;
changing the present operating point of the separately excited electric machine to a changed operating point by setting the variation voltage vector, wherein the power generated by the change in the operating point is equal to the power loss, particularly the thermal power loss, of the separately excited electric machine, or is less than the power loss, particularly the thermal power loss, of the separately excited electric machine;
executing an active short-circuit state proceeding from the changed operating point.

Accordingly, it is suggested that the present current vector and/or current angle of the separately excited electric machine is detected initially. Hereinafter, particularly the stator current vector is designated as current vector and particularly the stator current angle is designated as current angle. In particular, the position of the current vector and/or current angle in a defined coordinate system, particularly an alpha-beta coordinate system or a dq coordinate system, is detected. Subsequently, depending on the detected present current vector and/or current angle, a variation voltage vector is determined. In so doing, the position of the variation voltage vector in the above-described coordinate system can in turn be determined, particularly in relation to the previously detected present current vector and/or current angle. For example, the variation voltage vector has a determined position relative to the detected present current vector and/or current angle.

Subsequently, the present operating point of the separately excited electric machine is changed in a power-neutral manner to a changed operating point of the separately excited electric machine in that the previously determined variation voltage vector is set, and the power loss in the separately excited electric machine at least offsets or exceeds the power generated by the change in the operating point. In a special case, the change in the operating point may therefore be referred to as “power-neutral”.

This means, for example, that the present operating point of the separately excited electric machine is changed by setting the variation voltage vector in a changed operating point, specifically in such a way that not more than the thermal power loss resulting from this is generated. In other words, the variation voltage vector is set in the control of the separately excited electric machine and accordingly brings about a change in the operating point starting from the present operating point into the changed operating point. The change in the operating point prevents transient overcurrents so that transient currents in the separately excited electric machine are prevented from damaging electronic components in the separately excited electric machine. Further, the variation voltage vector is selected in such a way that it carries out the change in the operating point without power.

Accordingly, the separately excited electric machine or the electric drive arrangement can be provided for executing the active short-circuit state in which the above-described changed operating point is adopted. The changed operating point can lie, for example, as close as possible to a steady state AC current or a stationary ASC current with respect to the dq current coordinate system. Considering this coordinate system, the transition to the changed operating point is not linear but rather follows a curved path in the dq coordinate system. By changing the operating point into the changed operating point, the active short-circuit state can subsequently be carried out starting from the changed operating point without high transient currents flowing in the separately excited electric machine.

As has already been described, the variation voltage vector is determined on the basis of the detected present current vector and/or current angle. In an embodiment form of the method, the variation voltage vector can be determined with a defined phase shift, particularly in the range of +/−π/2, in relation to the detected current vector and/or current angle. As is well known, a defined phase shift between the current vector and the voltage vector, in this case, the variation voltage vector, does not cause any power to be generated in this range or by the above-described defined phase shift.

Further, it is possible that the defined phase shift is not adjusted exactly to +/−π/2 but rather selectively deviating therefrom. While power is slightly generated in this way, this is offset by the losses within the separately excited electric machine. This makes it possible to improve the change of the operating point from the present operating point to the changed operating point. In particular, the slight generation of power which is offset by the losses within the separately excited electric machine enables a closer approximation to the target operating point, particularly the steady state AC current or the center point of the spiral in the dq current coordinate system.

Purely by way of example, the defined phase shift between the variation voltage vector and the detected current vector and/or current angle can comprise a phase angle of 250° to 270°, particularly 255° to 265°. As has already been described, the exact phase angle or the exact phase shift can be adjusted depending on the losses occurring in the separately excited electric machine. The higher the losses, the more power can be generated, since this power can be offset by the losses. In other words, the higher the losses in the separately excited electric machine, the farther away the phase shift can be from π/2.

In addition, the described method can be further developed such that the variation voltage vector is shifted by an additional shift relative to the detected current vector and/or current angle depending on at least one power dissipation element. The defined phase shift can accordingly include the additional shift. The power dissipation element can form an additional element, for example, within the separately excited electrical arrangement, for example, a resistor, a varistor or the like, through which electrical power can be consumed or can be converted into power dissipation. In particular, the power dissipation element can transform electrical energy into heat and accordingly discharge it into the environment. For example, the power dissipation element can be arranged in parallel with the DC link in order that the power generated by setting the variation voltage vector is selectively consumed in the form of power dissipation when transitioning to the changed operating state.

In a further embodiment form of the method, it can be provided that a discharge voltage vector is set before setting the variation voltage vector in order to reduce the voltage, particularly depending on the detected current vector and/or current angle. Depending on the present operating state existing when the fault condition occurs or when the fault condition is detected, it can be useful to initially reduce the DC link voltage in the DC link or selectively bring about a voltage drop in order to set the variation voltage vector subsequently.

If the present voltage exceeds a determined voltage limit in the fault condition, for example, a permissible DC link voltage, the direct setting of the variation voltage vector can cause an additional increase in voltage. In order to ensure that the variation voltage vector can be set without negative consequences, the voltage is initially reduced by setting the discharge voltage vector so that the variation voltage vector can subsequently be reliably set. The discharge voltage vector can be set particularly in such a way that the voltage phasor and the current vector are approximately synchronized or run synchronously in order to selectively generate an active power to bring about the voltage drop.

In the above-described configuration, it can be provided in particular that the discharge voltage vector is set to a static state vector bounding the vector sector in which the present current vector and/or current angle is detected. As has been described, an active power is to be selectively generated for a period of time by the discharge voltage vector in order to bring about a voltage drop so that the variation voltage vector can subsequently be reliably carried out or set. By occupying the static state vector, it is advantageously possible that the switch positions in the inverter can remain static for the duration over which the discharge voltage vector is applied.

In other words, it is not necessary to generate the discharge voltage vector by modulating or changing the switch positions of the switch elements of the inverter, but rather the discharge voltage vector can be selectively positioned on a static state vector or set as such. To this end, the present current vector and/or current angle can be detected as was previously described. In this way, the vector sector of the hexagon describing the switch positions of the inverter can be identified in the coordinate system of the present current vector and/or current angle. On this basis, the discharge voltage vector can be set to that static state vector which bounds the present vector sector in which the present current vector and/or current angle was detected. In particular, the discharge voltage vector is set to the static state vector which trails the current vector and/or current angle or rearwardly bounds the vector sector. Thanks to the described setting of the discharge voltage vector to the static state vector in particular, neither a control or adjustment nor a modulation of the voltage vector is required, but rather the discharge voltage vector can be set in a particularly quick and simple manner, i.e., in particular with minimal computing time and computing power.

It can further be provided in the method that an electric decoupling of an electrical energy storage and/or an operation event of the separately excited electric machine and/or of a motor vehicle having the separately excited electric machine, is detected as fault condition particularly depending on an operating temperature of the separately excited electric machine. As was already described in the introduction, the detection of the fault condition can form the trigger for implementing the method. In this regard, the method can be carried out in particular exclusively when an electric decoupling of the electrical energy storage from which the separately excited electric machine is supplied or to which the separately excited electric machine can supply energy through recuperation is decoupled or the decoupling is imminent.

In this case, that is, it is not possible for electrical energy to be drawn from the electrical energy storage for operating the separately excited electric machine or changing the operating state, or for electrical energy to be fed into the separately excited electrical energy storage in a generator mode of the separately excited electric machine. As a result, an impermissible voltage increase occurs during a change in the operating point before ASC by another method. A direct ASC (not preceded by a change in the operating point) would prevent this, but high transient currents occur which in turn bring about strong opposing fields. On the other hand, if the electrical energy storage is not decoupled, methods other than the method described herein can also be employed because, in this case, there is no need to take into account the generated power when changing the present operating point.

Further, the fault condition can be detected as an operation event of the separately excited electric machine and/or of the motor vehicle having the separately excited electric machine. Such fault conditions can be, for example, accident states or crash states. In particular, the present operation event of the separately excited electric machine can be included in the fault condition, i.e., whether the separately excited electric machine is operated in a motor mode or in a generator mode. As has already been described, in generator mode in particular the DC link can be charged, namely, when the electrical energy storage is decoupled.

It can also be useful to carry out the method described above in motor mode, since, for example, the control of the voltage no longer functions flawlessly because, for example, controlled variables are no longer supplied to the voltage vector. As has been described above, the discharge voltage vector can be carried out as an option in the described cases, although it is not necessary in all present operating states or operation events. Further, the operating temperature of the separately excited electric machine can be taken into account in all states when the fault condition is detected. If the operating temperature is below a temperature limit, for example, then implementation of the method can possibly be dispensed with. Otherwise, for example, when the temperature limit value is exceeded, the method can be carried out in order to change the present operating point to the changed operating point and, only after that, adopt or execute the active short-circuit state.

In addition, the described method can be further developed in that the discharge voltage vector and/or the variation voltage vector are set for a defined period of time or a variable period of time, particularly depending on a present operating point. In the first alternative, a defined time period can be determined for the discharge voltage vector and/or the variation voltage vector during which the vectors can be set. In this regard, a first time period or discharge time period can be determined for the discharge voltage vector insofar as it is set. Further, a second time period or variation time period which can be distinct from the first time period can be determined for the variation voltage vector.

According to the second alternative, it can be provided that the defined time period, i.e., the first time period and/or the second time period, can be determined depending on a present operating point. This means, for example, that the first time period and/or the second time period can be changed depending on current and/or depending on voltage. For example, depending on the actual voltage level, the discharge voltage vector can be set for a longer or shorter period of time. Also, depending on current, for example, at high currents, a longer time period can be determined for setting the variation voltage vector or, at lower currents, a shorter time period can be determined for setting the variation voltage vector. As has already been described, the transition to the active short-circuit state is carried out after the variation voltage vector has been set, namely, after the changed operating point has been adopted.

In addition, the method can provide that the discharge voltage vector and/or the variation voltage vector are set statically or updated, particularly based on a change in the current vector and/or current angle. According to the first variant described above, the discharge voltage vector and/or the variation voltage vector can be set statically. This means that the latter are determined and remain unchanged over the duration of implementation. In other words, the discharge voltage vector and/or the variation voltage vector are set statically once and not changed until the voltage has been sufficiently reduced through the discharge voltage vector or until the changed operating state has been reached by setting the variation voltage vector.

In the second alternative, it can be provided that the discharge voltage vector and/or the variation voltage vector can be updated. For example, a change in the current vector and/or current angle can be detected for the duration in which the discharge voltage vector and/or variation voltage vector are set. As has already been described, the discharge voltage vector and/or the variation voltage vector can be determined based on the detected current vector and/or current angle. Accordingly, by detecting the change in the current vector and/or current angle, different discharge voltage vectors and variation voltage vectors can be determined and set at different times, i.e., they can be updated together with the current vector and/or current angle, or the discharge voltage vector and/or the variation voltage vector can be set in such a way that it or they “rotate along with” the current vector and/or current angle.

Moreover, the method can be further developed in such a way that the discharge voltage vector and/or the variation voltage vector are determined cyclically in particular before the fault condition occurs. In other words, the determination can be carried out cyclically throughout the operation of the separately excited electric machine so that the corresponding discharge voltage vector and/or variation voltage vector are always already determined for the actual operating state, i.e., the presently detected current vector and/or current angle. As soon as a fault condition occurs or has been detected, the discharge voltage vector determined last and/or the variation voltage vector determined last can be set directly without additional computing effort or lost time. This reduces computing effort and the time involved in the determination process when the fault condition occurs or when the fault condition is detected. Instead, vectors which have already been determined can be accessed and set directly.

Besides the method described above, the invention is also directed to a control device for controlling an operation of a separately excited electric machine, particularly of a motor vehicle, in a fault condition. The control device is configured to detect a present current vector and/or current angle of the separately excited electric machine, to determine a variation voltage vector depending on the detected present current vector and/or current angle, to change the present operating point of the separately excited electric machine to a changed operating point by setting the variation voltage vector such that the power generated by the change of the operating point is equal to the power loss, particularly thermal power loss, of the separately excited electric machine or less than the power loss, particularly thermal power loss, of the separately excited electric machine, and to execute an active short-circuit state starting from the changed operating point. The control device can be formed, for example, as an inverter of the drive arrangement or of the motor vehicle, or the control device can comprise such an inverter.

The invention is further directed to a drive arrangement which comprises a separately excited electric machine, an electrical energy storage and an above-described control device. The invention is further directed to a motor vehicle which comprises an above-described drive arrangement and/or an above-described control device.

All of the advantages, details and features which have been described with respect to the method are wholly transferable to the control device, the drive arrangement and the motor vehicle.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be described in the following through embodiment examples referring to the drawings. The drawings are schematic depictions and show:

FIG. 1 a schematic flow chart of a method for controlling the operation of a separately excited electric machine;

FIG. 2 a schematic state diagram; and

FIG. 3 a schematic voltage diagram.

### DETAILED DESCRIPTION OF THE PRESENTLY PREFERRED EMBODIMENTS

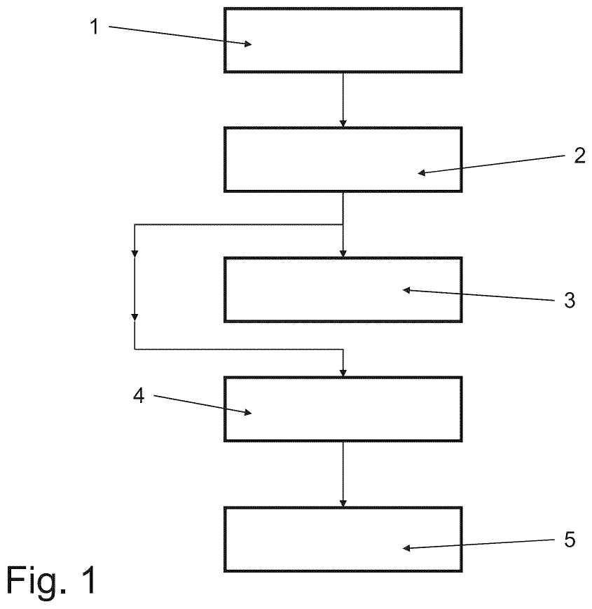

FIG. 1 shows, by way of example, with reference to boxes 1-5, the execution of the method described herein for controlling the operation of a separately excited electric machine, particularly a drive device of a motor vehicle. The separately excited electric machine may be a component part of a drive arrangement which comprises, for example, an electrical energy storage, an inverter and the separately excited electric machine. The inverter may be a component part of a control device or form the control device which is configured to control the operation of the separately excited electric machine.

The method starts, by way of example, in block 1 in which a fault condition of the separately excited electric machine exists or is detected. In block 1, it can be decided whether or not to carry out the method described herein. For example, if no fault condition exists, the separately excited electric machine can continue to be operated normally. If the fault condition is detected, it can be determined, for example, whether the electrical energy storage is electrically coupled to the drive arrangement or whether a so-called battery dump has been carried out in which the electrical energy storage has been electrically decoupled from the drive arrangement so that an electrical connection no longer exists. In such a case, for example, no electrical energy can be drawn from the electrical energy storage by the separately excited electric machine and no electrical energy can be fed into the electrical energy storage.

Optionally, further operation events of the motor vehicle, separately excited electric machine or drive arrangement can be detected, for example, whether or not an accident state or crash state exists. Optionally, the operating temperature of the separately excited electric machine or whether the present operating temperature lies above or below a temperature limit value can further be detected in block 1. The method described herein is carried out in particular when the operating temperature of the separately excited electric machine lies above the temperature limit. Block 1 proceeds to block 2 if it is determined in block 1 that a fault condition exists or is imminent, requiring that the method be carried out.

In an embodiment form of the method, blocks 2-4 can be carried out cyclically during the operation of the separately excited electric machine or of the drive arrangement so that the steps for determination or detection which are described in the following referring to blocks 2-4 are already executed, and the execution of blocks 2-4 is limited to setting the vectors which have already been determined. It is also possible that the vectors, particularly when there is sufficient computing power, are not detected until a fault condition occurs.

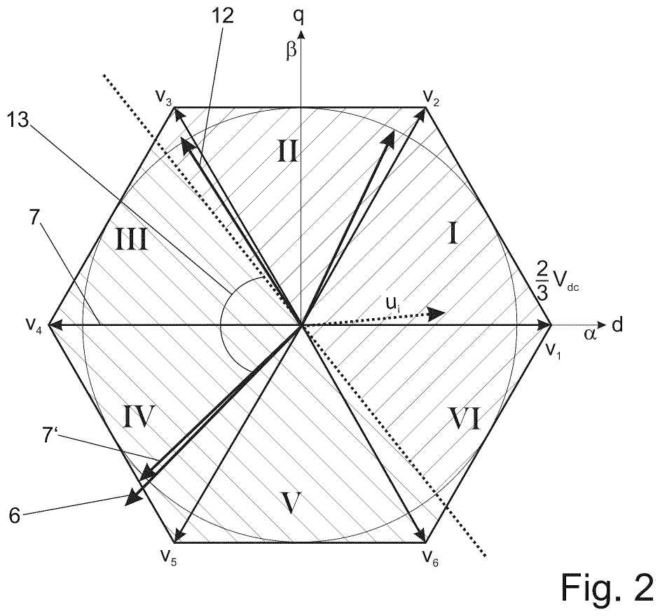

In block 2, the present current vector 6 and/or current angle or “current phasor” of the separately excited electric machine is detected. This is shown by way of example in FIG. 2 in the state diagram which shows the hexagon of the static switching states of the inverter, for example, in relation to a B6 bridge, in the form of vectors v1-v6. The latter delimit vector sectors I-VI from one another. In principle, any inverter or any control device can be used to control the separately excited electric machine. The corresponding state diagram is applicable to such cases and is merely illustrative in the present concrete example.

In the depicted exemplary embodiment, the present current vector 6 and/or current angle lies, for example, between the static state vectors v4 and v5, i.e., in vector sector IV. However, the state is changeable as needed so that the current vector 6 and/or current angle can also lie in any other vector sector I-VI or on one of the state vectors v1-v6. As has been described, the current vector 6 and/or current angle can be determined cyclically automatically in the operating state so that the previously determined or detected current vector 6 and/or current angle can be directly outputted in block 2.

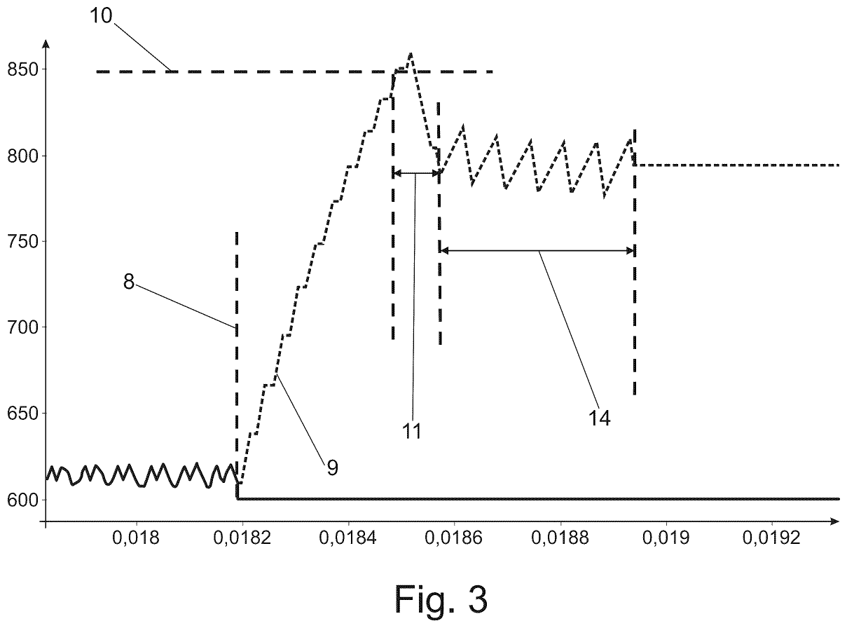

Optionally, block 2 can proceed to block 3 in which a discharge voltage vector 7 can be determined. For example, this can be carried out when the DC link voltage 9 (cf. FIG. 3) in the DC link lies above a defined voltage limit value 10. If the fault condition is detected, for example, starting from a generator mode of the separately excited electric machine, or the fault condition occurs in a generator mode of the separately excited electric machine so that no current can flow into the electrical energy storage due to the electrical decoupling of the electrical energy storage, this results in a charging of the DC link so that the DC link voltage 9 is increased. If the latter lies above the voltage limit value 10, the voltage can initially be reduced through the discharge voltage vector 7 in order subsequently to improve or enable further prosecution of the method. The voltage limit value in FIG. 3 is, purely illustratively, approximately 850 V. The transition to time domain 14 occurs after the expiration of time period 11 which has been determined beforehand.

The discharge voltage vector 7 is shown in FIG. 2. The discharge voltage vector 7 can be set, for example, for a first time period 11 (cf. FIG. 3) or discharge time period. If the discharge voltage vector 7 is not set, block 2 can proceed directly to block 4. The discharge voltage vector 7 is determined depending on the detected current vector 6 or current angle. To this end, it is sought that the discharge voltage vector 7 runs as parallel as possible to the current vector 6 or current angle so that active power can be generated in order to reduce the DC link voltage 9 in the DC link. An ideal discharge voltage vector 7′ is shown schematically in FIG. 2. Since the ideal discharge voltage vector 7′ lies between the static state vectors v4, v5, a comparatively elaborate control is needed for setting the discharge voltage vector. To simplify the control, the discharge voltage vector 7 is advantageously determined for the aforementioned first time period 11 on the static state vector v4 bounding vector sector IV in which the current vector 6 or current angle currently lies.

Purely by way of example, the current vector 6 or current angle currently lies in vector sector IV of the alpha-beta coordinate system which is bounded by state vectors v4, v5. Therefore, the discharge voltage vector 7 can be determined, for example, on the rearward static state vector v4 which rearwardly bounds vector sector IV in which the current vector 6 or current angle currently lies. Alternatively, the discharge voltage vector 7 can also be set on the foreword state vector v5 which forwardly bounds the present vector sector iV. Accordingly, the control of the inverter can advantageously be kept particularly simple, because no modulation is required; rather, the switching position for the first time period 11 can be kept constant. Alternatively, a setting of the discharge voltage vector 7′ is also possible, for example, when there is enough computing power or a sufficiently fast control is possible.

As has been described, the setting of the discharge voltage vector 7 is purely optional and, in case it is not required by the DC link voltage 9 in the DC link, it can also be dispensed with. A fault condition in which the discharge voltage vector 7 is set is shown purely illustratively in FIG. 3. For example, a fault condition is detected starting from a regular operating state at time point 8 so that the separately excited electrical energy storage is decoupled. In the depicted exemplary embodiment, the separately excited electric machine was operated in generator mode so that the DC link voltage 9 increases as a result of the decoupling of the separately excited electrical energy storage.

By way of example, the DC link voltage 9 exceeds the voltage limit value 10 so that the discharge voltage vector 7 is set as has been described. Subsequently, as soon as the first time period 11 has elapsed, block 3 can proceed to block 4. In the event that the voltage limit value 10 is not exceeded, as was also previously described, for example, when the separately excited electric machine is operated in a motor mode, the setting of the discharge voltage vector 7 can be omitted. For example, the discharge voltage vector 7 is set for the first time period 11. The first time period 11 can be set statically or determined depending on the present operating point, for example, by the DC link voltage. For example, the first time period 11 can be selected in such a way that the DC link voltage 9 falls below the voltage limit 10 again after the first time period 11 has elapsed.

In block 4, a variation voltage vector 12 is determined based on the current vector 6 or current angle which was detected in block 2. As has been described, this can be carried out cyclically before the fault condition occurs. The variation voltage vector 12 is determined in the depicted embodiment example with a defined phase shift 13 with respect to the current vector 6 or current angle. As was shown by way of example in FIG. 2, the variation voltage vector 12 is shifted by a phase angle in a range of π/2 with respect to the current vector 6 or current angle. Alternatively, the phase shift can also take place in the opposite direction, i.e., in a range of −π/2 with respect to the current vector 6 or current angle. As a result of this, no active power is generated by setting the variation voltage vector 12, and the present operating point of the separately excited electric machine can accordingly be transitioned to a changed operating point without generating power. The phase angle or phase shift 13 can deviate from π/2 and, for example, can be in a range of from 250° to 270°, in particular 255° to 265°.

In this regard, a low active power is generated but is offset by the losses within the separately excited electric machine so that the voltage in the DC link does not increase. The phase shift 13 can differ further from π/2 the more power loss is produced in the separately excited electric machine. To this end, there can be provided at least one power dissipation element, for example, a resistor, a varistor or the like, by which power can be selectively converted into heat. The power dissipation element is arranged, for example, in parallel with the DC link. Further, the phase shift 13 can also be determined depending on the operating point, for example, depending on the power dissipation currently produced in the separately excited electric machine. If high currents are flowing in the separately excited electric machine, for example, higher losses must be reckoned with so that the phase shift 13 can be selected correspondingly higher.

FIG. 3 shows that the variation voltage vector 12 is set for a second time period 14 or a variation time period. The generated discharge voltage vector 7 and the generated variation voltage vector 12 can be produced statically so that they do not change over time periods 11, 14. It is also possible that the latter are updated with the rotating current phasor 6, i.e., newly determined and set continuously at different time points within the time periods 11, 14. Static setting of vectors 7, 12 offers the advantage that the computing expenditure and control expenditure can be appreciably reduced. The accuracy of the method can be improved if they are continuously updated.

Proceeding from the changed operating point achieved in block 4, block 4 proceeds to block 5 in which the active short-circuit state can be carried out in order to bring the separately excited electric machine or the electric drive arrangement into the safe state. In FIG. 3, for example, the active short-circuit state follows the second time period 14. It is evident that setting the variation voltage vector 12 allows the operating point to be changed into the changed operating point in a power-neutral manner so that no high transient currents can flow when transitioning to the active short-circuit state.

As has been described, the method can be implemented on a control device, particularly by means of an inverter. The control device or inverter and the separately excited electric machine can be component parts of a drive arrangement. The drive arrangement is arranged in particular in a motor vehicle.

All of the details described with respect to the method are therefore also applicable to the control device, the drive arrangement and the motor vehicle. All of the advantages, details and features shown in the individual embodiment examples can be combined with one another, interchanged with one another and transferred to one another as needed.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for controlling an operation of a separately excited electric machine, particularly of a motor vehicle, in a fault condition, comprising the following steps:
detecting a present current vector, particularly a stator current vector, and/or a current angle, particularly a stator current angle, of the separately excited electric machine;
determining a variation voltage vector depending on the detected present current vector and/or current angle;
changing a present operating point of the separately excited electric machine to a changed operating point by setting the variation voltage vector, wherein the power generated by the change in the operating point is equal to the power loss, particularly the thermal power loss, of the separately excited electric machine, or is less than the power loss, particularly the thermal power loss, of the separately excited electric machine; and
executing an active short-circuit state of the separately excited electric machine proceeding from the changed operating point.

2. The method according to claim 1, wherein the variation voltage vector is determined with a defined phase shift, particularly in the range of +/−π/2, in relation to the detected current vector (6) and/or current angle.

3. The method according to claim 2, wherein the variation voltage vector is shifted by an additional shift relative to the detected current vector and/or current angle depending on at least one power dissipation element.

4. The method according to claim 1, wherein a discharge voltage vector is set before setting the variation voltage vector to reduce the voltage, particularly depending on the detected current vector and/or current angle.

5. The method according to claim 4, wherein the discharge voltage vector is set on a static state vector (v1-v6) which bounds the vector sector (I-VI) in which the present current vector and/or current angle is detected.

6. The method according to claim 1, wherein an electric decoupling of an electrical energy storage and/or an operation event of the separately excited electric machine and/or of the motor vehicle having the separately excited electric machine, is detected as fault condition particularly depending on an operating temperature of the separately excited electric machine.

7. The method according to claim 1, wherein the discharge voltage vector and/or the variation voltage vector are set for a defined time period or variable time period, particularly depending on a present operating point.

8. The method according to claim 1, wherein the discharge voltage vector and/or the variation voltage vector are set statically or updated, particularly based on a change in the current vector and/or current angle.

9. The method according to claim 1, wherein the discharge voltage vector and/or the variation voltage vector are determined cyclically, particularly before the fault condition occurs.

10. A control device for controlling an operation of a separately excited electric machine, particularly of a motor vehicle, in a fault condition, wherein the control device is configured to detect a present current vector and/or current angle of the separately excited electric machine, to determine a variation voltage vector depending on the detected present current vector and/or current angle, to change the present operating point of the separately excited electric machine to a changed operating point by setting the variation voltage vector such that the power generated by the change in the operating point is equal to the power loss, particularly the thermal power loss, of the separately excited electric machine, or is less than the power loss, particularly the thermal power loss, of the separately excited electric machine, and to execute an active short-circuit state starting from the changed operating point.

11. A drive arrangement comprising a separately excited electric machine, an electrical energy storage and a control device according to claim 10.
